(19) United States
(12) Patent Application Publication
(10) Pub. No.: US 2015/0007306 A1
(43) Pub. Date: Jan. 1, 2015

(54) ELECTRONIC DEVICE AND UNLOCKING METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: MIN YANG, Wuhan (CN); JIAN-HUNG HUNG, New Taipei (TW)

(21) Appl. No.: 14/317,096

(22) Filed: Jun. 27, 2014

(30) Foreign Application Priority Data
Jun. 27, 2013 (CN) 2013102622391

(51) Int. Cl. G06F 21/31

(52) U.S. Cl. CPC G06F 21/31
USPC 726/18

(57) ABSTRACT

A method for unlocking an electronic device detects unlocking touch operations of unlocking the electronic device on a touchscreen of the electronic device when the electronic device is locked. A number of touch points corresponding to each of the unlocking touch operations is confirm. The method further generates an input password according to the confirmed numbers of each of the unlocking touch operations and a touch sequence of the unlocking touch operations. When the input password matches an unlocking password prestored in a storage device of the electronic device, the electronic device is unlocked.

### CROSS-REFERENCE TO RELATED APPLICATIONS

This application claims priority to Chinese Patent Application No. 201310262239.1 filed on Jun. 27, 2013 in the China Intellectual Property Office, the contents of which are incorporated by reference herein.

### FIELD

Embodiments of the present disclosure relate to unlocking technology, and particularly to an electronic device and an unlocking method.

### BACKGROUND

Most electronic devices (for example, mobile phones) may be locked and unlocked by pressing a preset key or a combination of keys on keyboards of the electronic devices, or by implementing a slide operation on touch screens of the electronic devices. However, keys on the electronic device may wear because of frequent use of the preset key or combination of keys. The slide operation can easily be observed and stolen by others, and personal information of the electronic device may not be protected.

### BRIEF DESCRIPTION OF THE DRAWINGS

Implementations of the present disclosure will be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of one embodiment of an electronic device including an unlocking system.

FIG. 2 is flowchart of one embodiment of a method of setting an unlocking password of the electronic device in FIG. 1.

FIG. 3 is a diagrammatic view of one embodiment of touch operations on a touchscreen of electronic device of FIG. 1.

FIG. 4 is a flowchart of one embodiment of a method for unlocking the electronic device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more. ”

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives.

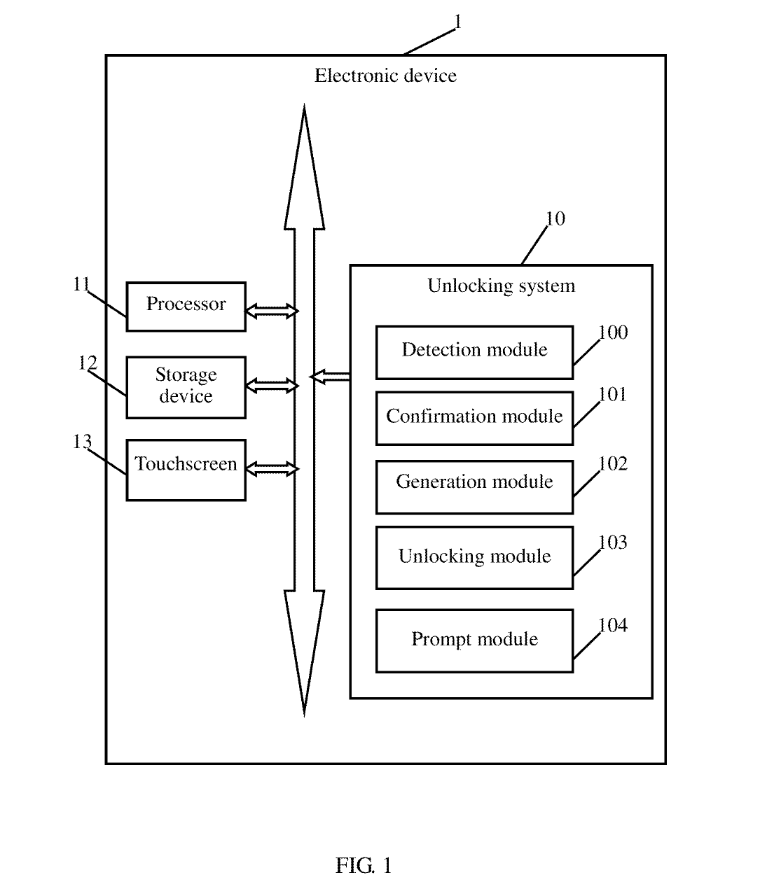

FIG. 1 is a block diagram of one embodiment of an electronic device including an unlocking system. In one embodiment, an electronic device 1 can be a mobile phone, a tablet computer, a notebook computer, or any other electronic device. The electronic device 1 further includes, but is not limited to, an unlocking system 10, at least one processor 11, a storage device 12, and a touchscreen 13. In one embodiment, the unlocking system 10 can preset an unlocking password according to touch operations, and unlock the electronic device 1 when an input password generated by recognizing input touch operations matches the unlocking password.

The at least one processor 11 executes one or more computerized codes and other applications of the electronic device 1 to provide functions of the unlocking system 10. The storage device 12 can be a memory of the electronic device 1 or an external storage card, such as a smart media card or a secure digital card. The touchscreen 13 can support multi-touch operations. In the embodiment, the multi-touch operations represent more than one touch point of contact with the touchscreen 13, such as simultaneously tapping, touching, pressing and sliding on the touchscreen 13 using one or more fingers.

In this embodiment, the unlocking system 10 includes a detection module 100, a confirmation module 101, a generation module 102, an unlocking module 103, and a prompt module 104. The modules 100-104 include computerized code in the form of one or more programs that are stored in the storage device 12. The computerized code includes instructions that are executed by the at least one processor 11 to provide functions of the unlocking system 10.

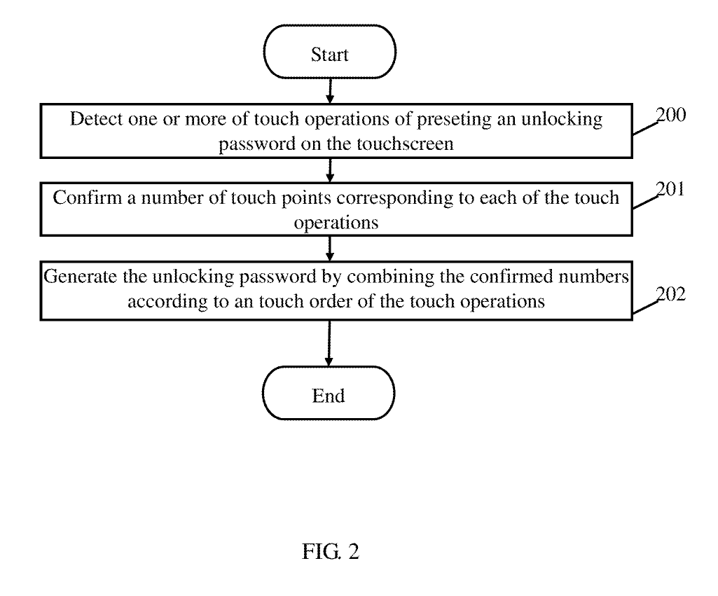

FIG. 2 is flowchart of one embodiment of a method of setting an unlocking password of the electronic device in FIG. 1. Depending on the embodiment, additional blocks can be added, others can be removed, and the sequencing of the blocks can be changed.

In block 201, the detection module 100 detects touch operations of presetting an unlocking password on the touchscreen 13 when the electronic device 1 is required to start presetting the unlocking password. The touch operations can be a combination of single point touches and/or multi-touches. In at least one embodiment, the single point touch includes one touch point, and the multi-touch includes one or more than one touch point.

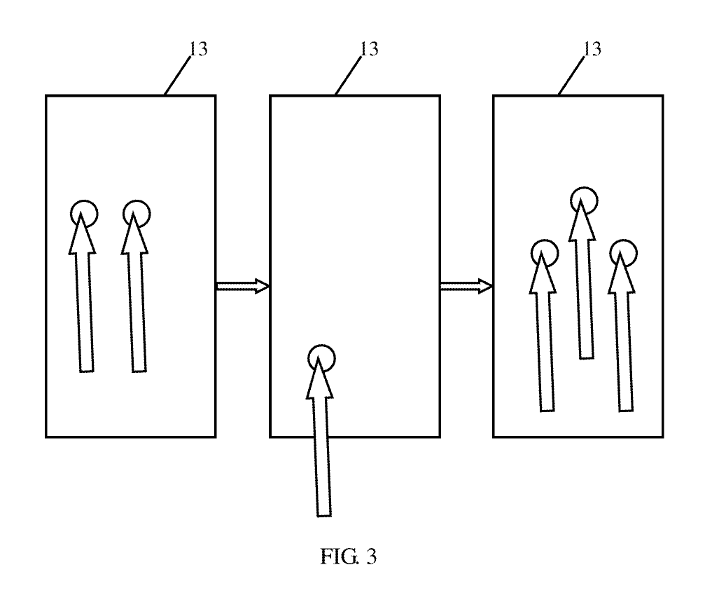

In block 202, the confirmation module 101 confirms a number of touch points corresponding to each of the touch operations. For example, FIG. 3 is a diagram of one embodiment of touch operations on the touchscreen 13 of electronic device 1. As shown in FIG. 3, three touch operations are detected on the touchscreen 13. The confirmation module 101 confirms that a number of touch points corresponding to a first touch operation is two, a number of touch points corresponding to a second touch operation is one, and a number of touch points corresponding to a third touch operation is three.

In block 202, the generation module 102 generates the unlocking password by combining the confirmed numbers according to a touch sequence of the touch operations, and stores the unlocking password in the storage device 12. For example, according to the touch operations shown in FIG. 3, the generation module 102 can generates an unlocking password “213”.

In one embodiment, a first icon can be displayed on the touchscreen 13 to start to preset the unlocking password. The first icon can be one or more virtual buttons. After the first icon is operated, the first icon can be hidden and a second icon can be displayed on the touchscreen 13. The second icon can be operated to finish an unlocking procedure. When the second icon is operated, the touch operations for presetting the unlocking password are determined to be finished. In other embodiments, one or more physical buttons can be predetermined to replace the first icon and the second icon to start presetting the unlocking password and finish presetting the unlocking password. Then no icon is needed to be displayed on the touchscreen 13.

In some embodiments, the first icon and the second icon can be the same icon. When the user starts to preset the unlocking password, the user can operate the first icon and execute the touch operations to preset the unlock password. When the first icon is operated again, the touch operations are determined to be finished.

In other embodiments, the touch operations can be determined to be finished when no more touch operation is detected in a preset time duration (for example, 5 seconds).

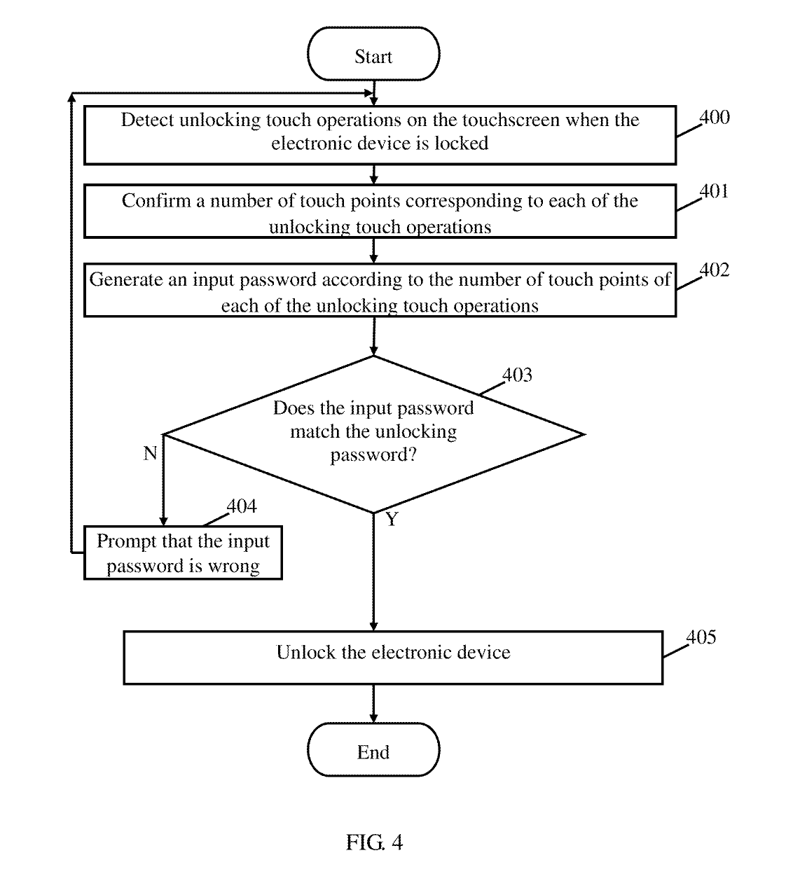

FIG. 4 is flowchart of one embodiment of a method of unlocking the electronic device in FIG. 1. Depending on the embodiment, additional blocks can be added, others can be removed, and the order of the blocks can be changed.

In block 400, the detection module 100 detects unlocking touch operations of unlocking the electronic device 1 on the touchscreen 13, when the electronic device 1 is locked. In the embodiment, when the first icon is detected to be operated, the detection module 100 can start to detect the unlocking touch operations. When the second icon is detected to be operated, the detection module 100 determines that the unlocking touch operations are finished.

In block 401, the confirmation module 101 confirms a number of touch points corresponding to each of the unlocking touch operations.

In block 402, the generation module 102 generates an input password according to the confirmed numbers of each of the unlocking touch operations and a touch sequence of the unlocking touch operations.

In block 403, the unlocking module 103 determines whether the input password matches the unlocking password stored in the storage device 12. For example, when the input password is identical to the unlocking password, the unlocking module 103 determines that the input password matches the unlocking password, and block 405 is implemented. If the input password is different from the unlocking password, the unlocking module 103 determines that the input password does not match the unlocking password, and block 404 is implemented.

In block 404, the prompt module 104 prompts the user of the electronic device 1 that the input password is wrong, and the procedure returns to block 400. In one embodiment, the prompt module 104 can display a prompt message on the touchscreen 13 or output an audio prompt using a speaker of the electronic device 1.

In block 405, the unlocking module 103 unlocks the electronic device 1, and the procedure ends.

In some embodiments, the detection module 100 can further confirm an unlocking time period of the touch operations of presetting the unlocking password, and the detection module 100 can detect a time period of the unlocking touch operations in block 400. If the detected time period is greater than the unlocking time period, block 404 is implemented. If the detected time period is less than or equal to the unlocking time period, block 401 is implemented.

In other embodiments, the detection module 100 can further confirm a preset touch times according to touch times of the touch operations of presetting the unlocking password, and the detection module 100 can detect touch times of the unlocking touch operations in block 400. If the detected touch times is identical to the preset touch times, block 401 is implemented. If the detected touch times is different from the preset touch times, block 404 is implemented.

All of the processes described above may be embodied in, and fully automated via, functional code modules executed by one or more general purpose processors such as the processor 11. The code modules may be stored in any type of non-transitory readable medium or other storage device such as the storage device 12. Some or all of the methods may alternatively be embodied in specialized hardware. Depending on the embodiment, the non- transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A computer-implemented method for unlocking an electronic device, the method comprising:
detecting unlocking touch operations of unlocking the electronic device on a touchscreen of the electronic device when the electronic device is locked, each of the unlocking touch operations corresponding to one or more touch points;
confirming a number of touch points corresponding to each of the unlocking touch operations;
generating an input password according to the confirmed numbers of each of the unlocking touch operations and a touch sequence of the unlocking touch operations; and
unlocking the electronic device when the input password matches an unlocking password prestored in a storage device of the electronic device.

2. The method according to claim 1, wherein the unlocking password is prestored by:
detecting touch operations for presetting the unlocking password on the touchscreen when the electronic device starts to preset the unlocking password;
confirming a number of touch points corresponding to each of the touch operations; and
generating the unlocking password by combining the confirmed numbers according to a touch sequence of the unlocking touch operations, and storing the unlocking password in the storage device.

3. The method according to claim 2, further comprising:
displaying a first icon on the touchscreen to start to unlock the electronic device or to start to preset the unlocking password;
displaying a second icon on the touchscreen when the first icon is operated;
determining that the touch operations or the unlocking touch operations are finished when the second icon is operated.

4. The method according to claim 2, further comprising:
determining an unlocking time period of the touch operations of presetting the unlocking password, and detecting a time period of the unlocking touch operations;
confirming the number of the touch points corresponding to each of the unlocking touch operations when the detected time period is less than or equal to the unlocking time period.

5. The method according to claim 2, further comprising:
confirming preset touch times according to touch times of the touch operations of presetting the unlocking password, and detecting touch times of the unlocking touch operations;
confirming the number of the touch points corresponding to each of the unlocking touch operations when the detected touch times is identical to the preset touch times.

6. The method according to claim 1, further comprising:
prompting that the input password is wrong when the input password does not match the unlocking password.

7. A non-transitory storage medium storing a set of instructions, when executed by at least one processor of an electronic device, cause the at least one processor to perform a method for unlocking the electronic device, the method comprising:
detecting unlocking touch operations of unlocking the electronic device on a touchscreen of the electronic device when the electronic device is locked, each of the unlocking touch operations corresponding to one or more touch points;
confirming a number of touch points corresponding to each of the unlocking touch operations;
generating an input password according to the confirmed numbers of each of the unlocking touch operations and a touch sequence of the unlocking touch operations; and
unlocking the electronic device when the input password matches an unlocking password prestored in a storage device of the electronic device.

8. The storage medium according to claim 7, wherein the unlocking password is prestored by:
detecting touch operations for presetting the unlocking password on the touchscreen when the electronic device starts to preset the unlocking password;
confirming a number of touch points corresponding to each of the touch operations; and
generating the unlocking password by combining the confirmed numbers according to a touch sequence of the unlocking touch operations, and storing the unlocking password in the storage device.

9. The storage medium according to claim 8, further comprising:
displaying a first icon on the touchscreen to start to unlock the electronic device or to start to preset the unlocking password;
displaying a second icon on the touchscreen when the first icon is operated;
determining that the touch operations or the unlocking touch operations are finished when the second icon is operated.

10. The storage medium according to claim 8, further comprising:
determining an unlocking time period of the touch operations of presetting the unlocking password, and detecting a time period of the unlocking touch operations;
confirming the number of the touch points corresponding to each of the unlocking touch operations when the detected time period is less than or equal to the unlocking time period.

11. The storage medium according to claim 8, further comprising:
confirming preset touch times according to touch times of the touch operations of presetting the unlocking password, and detecting touch times of the unlocking touch operations;
confirming the number of the touch points corresponding to each of the unlocking touch operations when the detected touch times is identical to the preset touch times.

12. The storage medium according to claim 7, further comprising:
prompting that the input password is wrong when the input password does not match the unlocking password.

13. An electronic device, comprising:
a touchscreen;
at least one processor; and
a storage device storing one or more programs, which when executed by the at least one processor, cause the at least one processor to:
detect unlocking touch operations of unlocking the electronic device on the touchscreen when the electronic device is locked, each of the unlocking touch operations corresponding to one or more touch points;
confirm a number of touch points corresponding to each of the unlocking touch operations;
generate an input password according to the confirmed numbers of each of the unlocking touch operations and a touch sequence of the unlocking touch operations; and
unlock the electronic device when the input password matches an unlocking password prestored in the storage device.

14. The electronic device according to claim 13, wherein the at least one processer further detects touch operations for presetting the unlocking password on the touchscreen when the electronic device starts to preset the unlocking password;
confirms a number of touch points corresponding to each of the touch operations; and
generates the unlocking password by combining the confirmed numbers according to a touch sequence of the unlocking touch operations, and stores the unlocking password in the storage device.

15. The electronic device according to claim 14, wherein the at least one processer further displays a first icon on the touchscreen to start to unlock the electronic device or to start to preset the unlocking password;
displays a second icon on the touchscreen when the first icon is operated;
determines that the touch operations or the unlocking touch operations are finished when the second icon is operated.

16. The electronic device according to claim 14, wherein the at least one processer further determines an unlocking time period of the touch operations of presetting the unlocking password, and detects a time period of the unlocking touch operations;
confirms the number of the touch points corresponding to each of the unlocking touch operations when the detected time period is less than or equal to the unlocking time period.

17. The electronic device according to claim 14, wherein the at least one processer further confirms preset touch times according to touch times of the touch operations of presetting the unlocking password, and detects touch times of the unlocking touch operations;
confirming the number of the touch points corresponding to each of the unlocking touch operations when the detected touch times is identical to the preset touch times.

18. The electronic device according to claim 13, wherein the at least one processer further prompts that the input password is wrong when the input password does not match the unlocking password.
